(19) United States
(12) Patent Application Publication
(10) Pub. No.: US 2007/0160066 A1
(43) Pub. Date: Jul. 12, 2007

(54) DISPLAY AND METHOD OF DRIVING THE SAME

(76) Inventor: Yoshiro Aoki, Kitamoto-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/687,308

(22) Filed: Mar. 16, 2007

Related U.S. Application Data
(63) Continuation of application No. PCT/JP05/17631, filed on Sep. 26, 2005.

(30) Foreign Application Priority Data
Sep. 28, 2004 (JP) 2004-282677

(51) Int. Cl. H04L 12/56

(52) U.S. Cl. 370/396

(57) ABSTRACT

In a write period, a write current is caused to flow through a video signal line in a first state where a first control terminal and an output terminal of a drive control element, a second control terminal of a drive control element, and a video signal line are connected one another and a potential of a scan signal line is set at a first potential, and the potential of the scan signal line is shifted from the first potential to a second potential in a second state where the first and second control terminals, the output terminal, and the video signal line are disconnected from one another are sequentially executed. In a effective display period, a drive current is caused to flow through a display element while keeping the potential of the scan signal line at the second potential.

### CROSS-REFERENCE TO RELATED APPLICATIONS

This is a Continuation Application of PCT Application No. PCT/JP2005/017631, filed Sep. 26, 2005, which was published under PCT Article 21(2) in Japanese.

This application is based upon and claims the benefit of priority from prior Japanese Patent Application No. 2004-282677, filed Sep. 28, 2004, the entire contents of which are incorporated herein by reference.

### BACKGROUND OF THE INVENTION

1. Field of the Invention

The present invention relates to a display and a method of driving the same, in particular, a display that controls optical characteristics of each display element by magnitude of a drive current passed therethrough and a method of driving the same.

2. Description of the Related Art

On a display such as organic electroluminescent (EL) display that controls optical characteristics of each display element by magnitude of a drive current passed through the display element, image quality deterioration such as luminance unevenness occurs if magnitudes of the drive currents vary. Therefore, when an active matrix driving method is employed in this display, the pixels must be the same in characteristics of a drive control element for controlling the magnitude of the drive current. In this display, however, the drive control elements are normally formed on an insulator such as glass substrate, so the characteristics of them easily vary.

U.S. Pat. No. 6,373,454 describes an organic EL display employing a current copy circuit in a pixel.

This pixel includes an n-channel FET (field-effect transistor) as the drive control element, organic EL element, and capacitor. The source of the n-channel FET is connected to a power supply line at a lower electric potential, and the capacitor is connected between the gate of the n-channel FET and the power supply line. The anode of the organic EL element is connected to a power supply line at a higher electric potential.

The pixel circuit is driven by the method described below.

First, the drain of the n-channel FET is connected to its gate. A current I_{sig} at magnitude corresponding to a video signal is made to flow between the drain and source of the n-channel FET. This operation sets the voltage between electrodes of the capacitor, equal to a gate-to-source voltage necessary for the n-channel FET to pass the current I_{sig} through its channel.

Then, the gate of the n-channel FET is disconnected from its drain, and the voltage between the electrodes of the capacitor is maintained. The drain of the n-channel FET is subsequently connected to the cathode of the organic EL element. This allows a drive current to flow through the organic EL element at magnitude almost equal to that of the current I_{sig}. The organic EL element emits light at a luminance corresponding to the magnitude of the drive current.

As described above, when the current copy circuit is employed in each pixel circuit, it is possible to make the drive current flow between the drain and source of the n-channel FET during a retention period following a write period at magnitude almost equal to that of the current I_{sig} supplied as a video signal during the write period. Therefore, the influence of not only the threshold value Vₜₕ but also the mobility, dimensions, and the like of the n-channel FET on the drive current can be eliminated.

However, it is difficult for the display, which employs the current copy circuit in each pixel circuit, to make the drive current sufficiently small. If the drive current cannot be set sufficiently small in, for example, organic EL display, each gray level within a low gray level range is displayed at a luminance higher than that to be displayed. Consequently, high contrast is difficult to achieve.

### BRIEF SUMMARY OF THE INVENTION

An object of the present is to make it possible that a small drive current flows through a display element.

According to a first aspect of the present invention, there is provided a display comprising pixels arranged in a matrix, first scan signal lines arranged correspondently with rows which the pixels form, and video signal lines arranged correspondently with columns which the pixels form, wherein each of the pixels comprises a first drive control element including a first control terminal, a first input terminal connected to a first power supply terminal, and a first output terminal outputting a current whose magnitude corresponds to a voltage between the first control terminal and the first input terminal, a second drive control element including a second control terminal, a second input terminal connected to the first output terminal, and a second output terminal outputting a current whose magnitude corresponds to a voltage between the second control terminal and the second input terminal, a first capacitor connected between a constant potential terminal and the first control terminal, a second capacitor connected between the first scan signal line and the second control terminal, a display element whose optical characteristic changes in accordance with a magnitude of current flowing therethrough, an output control switch connected in series with the display element between the second output switch and a second power supply terminal, and a switch group switching a connection state of the first and second control terminals, the first output terminal, and the video signal line between first and second states, the first state being a state where the first and second control terminals, the first output terminal, and the video signal line are connected to one another, and the second state being a state where the first and second control terminals, the first output terminal, and the video signal line are disconnected from one another.

According to a second aspect of the present invention, there is provided a method of driving the display according to claim 1, comprising sequentially executing first and second operations in a write period during which the output control switch is opened, the first operation including causing a write current to flow through the video signal line while the connection state is set to the first state and a potential of the first scan signal line is set at a first potential, and the second operation including shifting the potential of the first scan signal line from the first potential to a second potential while the connection state is set to the second state, and causing a drive current corresponding to the write current to flow through the display element while keeping the connection state to the second state and the potential of the first scan signal line at the second potential in an effective display period during which the output switch is closed.

### BRIEF DESCRIPTION OF THE SEVERAL VIEWS OF THE DRAWING

FIG. 1 is a plan view schematically showing a display according to a first embodiment of the present invention;

FIG. 2 is a timing chart schematically showing an example of a method of driving the display shown in FIG. 1;

FIG. 3 is an equivalent circuit diagram showing a pixel from which a second drive control element, second capacitor, and second switch are omitted;

FIG. 4 is a graph showing an example of volt-ampere characteristics of a drive control element in the pixel shown in FIG. 3;

FIG. 5 is a graph showing another example of volt-ampere characteristic of a drive control element in the pixel shown in FIG. 3; and

FIG. 6 is a plan view schematically showing a display according to a second embodiment of the present invention.

### DETAILED DESCRIPTION OF THE INVENTION

Embodiments of the present invention will be described below in detail with reference to the drawings. In the drawings, the same reference symbol denotes components having the same or similar functions and duplicate descriptions will be omitted.

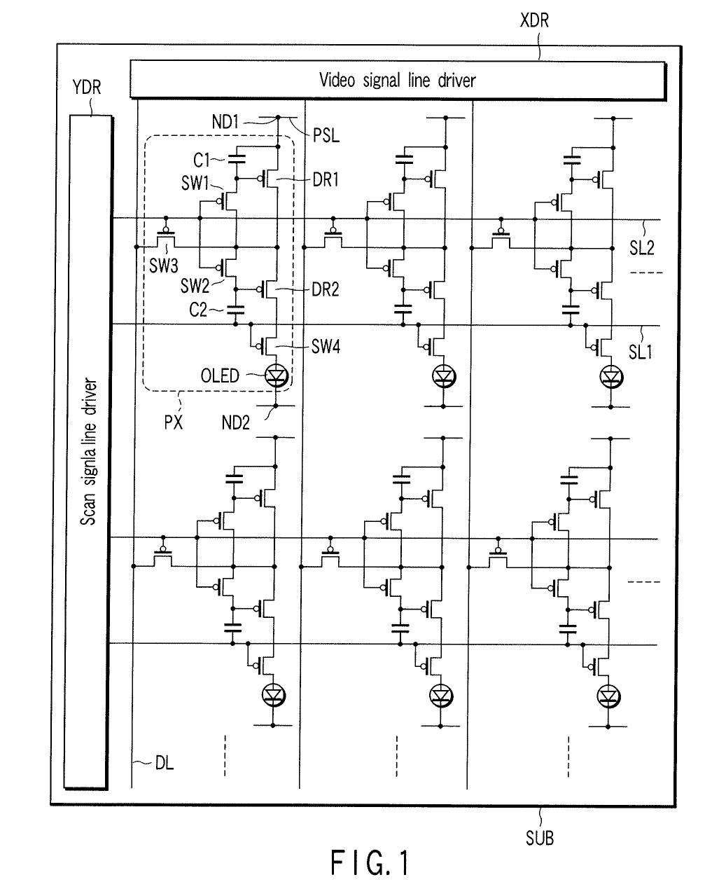

FIG. 1 is a plan view schematically showing a display according to the first embodiment of the present invention. The display is an active matrix display, for example, an active matrix organic EL display, and includes a plurality of pixels PX. The pixels PX are arranged in a matrix on an insulating substrate SUB.

A scan signal line drive YDR and video signal line driver XDR are further arranged on the substrate SUB.

On the substrate SUB, scan signal lines SL1 and SL2 extend in a direction along rows of the pixels PX and alternately arranged in a direction along columns of the pixels PX. The scan signal lines SL1 and SL2 are connected to the scan signal line driver YDR. The scan signal line driver YDR supplies scan signals to the scan signal lines SL1 and SL2.

Further, on the substrate SUB, video signal lines DL extend in the direction along columns of the pixels PX and arranged in the direction along rows of the pixels PX. The video signal lines DL are connected to the video signal line driver XDR. The video signal line driver XDR supplies video signals to the video signal lines DL.

In addition, on the substrate SUB, power supply lines PSL are arranged.

Each pixel PX includes a first drive control element DR1, second drive control element DR2, first switch SW1, second switch SW2, third switch SW3, output control switch SW4, first capacitor C1, second capacitor C2, and display element OLED. The switches SW1 to SW3 form a switch group.

The display element OLED includes anode and cathode facing each other, and an active layer whose optical characteristics changes in accordance with magnitude of current flowing between the anode and cathode. As an example, the display element OLED is an organic EL element including an emitting layer as the active layer. Further, as an example, the anode is a bottom electrode, and the cathode is a top electrode that faces the bottom electrode with the active layer interposed therebetween.

The first drive control element DR1 includes a first control terminal, first input terminal, and first output terminal that output current at magnitude corresponding to voltage between the first control terminal and first input terminal. As an example, the drive control element DR1 is a p-channel thin-film transistor (TFT) whose gate as the control terminal is connected to an electrode of the first capacitor C1, and whose source as the input terminal is connected to the power supply line PSL. Note that a node ND1 on the power supply line PSL corresponds to a first power supply terminal.

The second drive control element DR2 includes a second control terminal, second input terminal, and second output terminal that output current at magnitude corresponding to voltage between the second control terminal and second input terminal. As an example, the drive control element DR2 is a p-channel TFT whose gate as the control terminal is connected to an electrode of the second capacitor C2, and whose source as the input terminal is connected to the first output terminal of the first drive control element DR1.

The switch group including the switches SW1 to SW3 switches between a first state that the control terminal of the drive control element DR1, the control terminal of the drive control element DR2, the output terminal of the drive control element DR2, and the video signal line DL are connected to one another, and a second state that they are disconnected from one another. The switch group can employ various configurations. This is described in detail later.

The first switch SW1 has a terminal connected to the control terminal of the drive control element DR1. The switch SW1 switches alone or in combination with the switch SW2 and/or switch SW3 between a state that the output terminal and control terminal of the drive control element DR1 are connected to each other and a state that they are disconnected from each other.

For example, the switch SW1 is connected between the control terminal and output terminal of the drive control element DR1. A switching operation of the switch SW1 is controlled by, for example, a scan signal supplied from the scan signal line driver YDR via the scan signal line SL2. As an example, the switch SW1 is a p-channel TFT a whose gate is connected to the scan signal line SL2 and whose source and drain are connected to the gate and drain of the drive control element DR1, respectively.

The second switch SW2 has a terminal connected to the control terminal of the drive control element DR2. The switch SW2 switches alone or in combination with the switch SW1 and/or switch SW3 between a state that the output terminal of the drive control element DR1 and the control terminal of the drive control element D2 are connected to each other and a state that they are disconnected from each other.

For example, the switch SW2 is connected between the control terminal of the drive control element DR2 and the output terminal of the drive control element DR1. A switching operation of the switch SW2 is controlled by, for example, a scan signal supplied from the scan signal line driver YDR via the scan signal line SL2. As an example, the switch SW2 is a p-channel TFT a whose gate is connected to the scan signal line SL2 and whose source and drain are connected to the output terminal of the drive control element DR1 and the control terminal of the drive control element DR2, respectively.

The third switch SW3 has a terminal connected to the output terminal of the drive control element DR1 or the video signal line DL. The switch SW3 switches alone or in combination with the switch SW1 and/or switch SW2 between a state that the output terminal of the drive control element DR1 and the video signal line DL are connected to each other and a state that they are disconnected from each other.

For example, the switch SW3 is connected between the output terminal of the drive control element DR1 and the video signal line DL. A switching operation of the switch SW3 is controlled by, for example, a scan signal supplied from the scan signal line driver YDR via the scan signal line SL2. As an example, the switch SW3 is a p-channel TFT a whose gate is connected to the scan signal line SL2 and whose source and drain are connected to the output terminal of the drive control element DR1 and the video signal line DL, respectively.

The output control switch SW4 and display element OLED are connected in series between the output terminal of the drive control element DR2 and a second power supply terminal ND2. As an example, the switch SW4 is a p-channel TFT whose gate is connected to the scan signal line SL1 via the capacitor C2 and whose source and drain are connected to the output terminal of the drive control element DR2 and the anode of the display element OLED, respectively. Although the output control switch SW4 and display element OLED are connected in series between the output terminal of the drive control element DR2 and the second power supply terminal ND2 in this order, they may be connected in series in the reverse order.

The capacitor C1 is connected between a constant-potential terminal and the control terminal of the drive control element DR1. The capacitor C2 is connected between the control terminal of the drive control element DR2 and the scan signal line SL1. As an example, the capacitor C1 is connected between the node on the power supply line PSL and the gate of the drive control element DRI. The constant-potential terminal to which the capacitor C1 is connected may be electrically insulated from the power supply line PSL. That is, as the above constant-potential terminal, another constant-potential terminal electrically insulated from the power supply line PSL may be used.

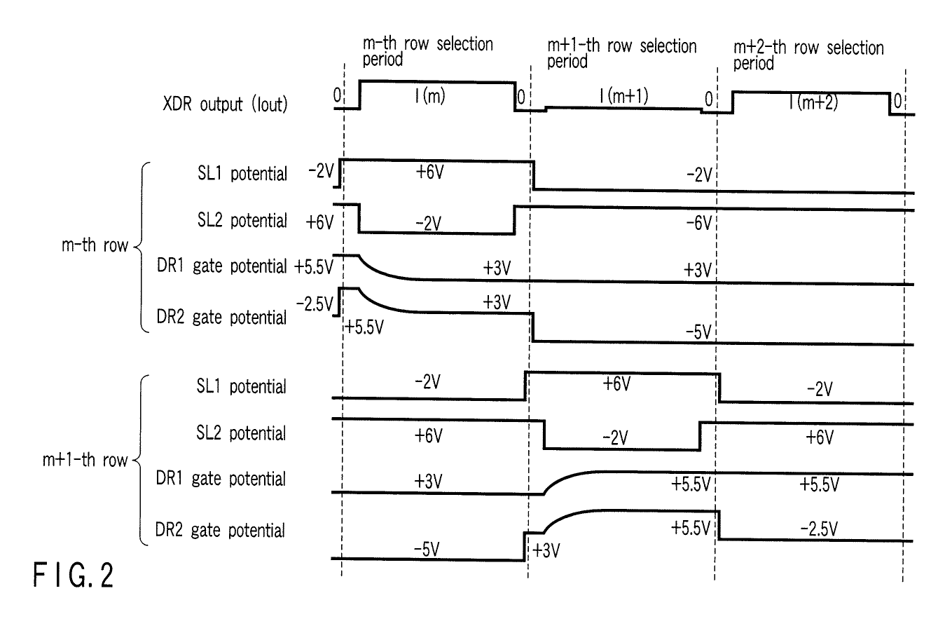

FIG. 2 is a timing chart schematically showing an example of a method of driving the display shown in FIG. 1.

In FIG. 2, the abscissa denotes time, while the ordinate denotes potential or magnitude of current. In FIG. 2, the waveform indicated as “XDR output (Iₒᵤₜ)” shows current that the video signal line driver XDR makes flow through the video signal line DL, the waveforms indicated as “SL1 potential” and “SL2 potential” show potentials of the scan signal lines SL1 and SL2, respectively, and the waveforms indicated as “DR1 gate potential” and “DR2 gate potential” show potentials of the gate potentials of the drive control elements DR1 and DR2, respectively. Further, in FIG. 2, “I(m+k)” represents magnitude of current or current that flows during an “m+k-th row selection period” over which a pixel PX in an “m+k-th row” is selected, through the video signal line DL to which the above pixel PX is connected.

FIG. 2 shows an example in which a gray level to be displayed on a pixel PX in the m-th row is changed from a gray level corresponding to a drive current with a smaller magnitude to a gray level corresponding to a drive current with a larger magnitude, and a gray level to be displayed on a pixel PX in the m+1-th row is changed from a gray level corresponding to a drive current with a larger magnitude to a gray level corresponding to a drive current with a smaller magnitude. Further, in the method shown in FIG. 2, as an example, potentials of the power supply terminals ND1 and ND2 are set at +6 V and −9 V, respectively, and magnitude of each scan signal supplied to the scan signal lines SL1 and SL2 are switched between +6 V and −2 V.

According to the method shown in FIG. 2, the display shown in FIG. 1 is driven as follows.

When a gray level corresponding to a drive current with a larger magnitude is to be displayed on a pixel PX in the m-th row, during a period over which the pixel PX in the m-th row is selected, that is, an m-th row selection period, the potential of the scan signal line SL1 is changed from −2 V as a second potential to +6 V as a first potential so as to open the switch SW4, for example. Note that the gate potential of the drive control element DR2 changes in accordance with the change in potential of the scan signal line SL1. During a write period over which the switch SW4 is open, the first and second operations are executed sequentially.

First, the potential of the scan signal is changed from +6 V to −2 V so as to close switches SW1 to SW3, for example. Thus, the gate of the drive control element DR1, the gate of the drive control element DR2, the drain of the drive control element DR1, and the video signal line DL are connected to one another. In this state, a video signal is supplied from the video signal line driver XDR via the video signal line DL to the selected pixel PX. That is, the video signal line driver XDR makes a current I(m) flow from the power supply terminal ND1 to the video signal line DL. Magnitude of the current I(m) corresponds to magnitude of the drive current to be supplied to the display element OLED, that is, the gray level to be displayed on the selected pixel PX.

This first operation sets the gate potential of the drive control element DR1 at a value when the current I(m) flows between the gate and drain of the drive control element DR1. In the example shown in FIG. 2, the gate potential of the drive control element DR1 is set at +3 V by the first operation. The first operation also sets the gate potential of the drive control element DR2 at a value equal to the gate potential of the drive control element DR1, +3 V in this example.

Next, the potential of the scan signal line SL2 is changed from −2 V to +6 V so as to open the switches SW1 to SW3, for example. That is, the gate of the drive control element DR1, the gate of the drive control element DR2, the drain of the drive control element DR1, and the video signal line DL are disconnected from one another. Subsequently, in this state, the potential of the scan signal line SL1 is changed from +6 V as the first potential to −2 V as the second potential so as to close the switch SW4.

This second operation changes the gate potential of the drive control element DR2 in accordance with the change in potential of the scan signal line SL1. In this example, the gate potential of the drive control element DR2 is changed from +3 V to −5 V.

As described above, the gate potential of the drive control element DR1 is set at a value when the current I(m) flows, +3 V in this example, by the first operation. This gate potential is maintained until the switches SW1 to SW3 are closed.

Further, as described above, the gate potential of the drive control element DR2 is set at a value that is obtained by adding a difference between the second potential (−2 V) and the first potential (+6 V) to the gate potential (+3 V) just after finishing the first operation, that is, −5 V in this example. This gate potential is maintained until the potential of the scan signal line SL1 is changed from the second potential to the first potential.

Thus, an electrical resistance of the drive control element DR2 is small during the effective display period. Therefore, a drive current with a sufficiently large magnitude can flow through the display element OLED. According to the method shown in FIG. 2, a gray level corresponding a drive current with a large magnitude can be displayed as described above.

According to the method shown in FIG. 2, when a gray level corresponding to a drive current with a smaller magnitude is to be displayed, the display shown in FIG. 1 is driven as follows.

When a gray level corresponding to a drive current with a smaller magnitude is to be displayed on a pixel PX in the m+1-th row, similar to the method described with regard to the pixel PX in the m-th row, the first and second operations are sequentially executed during a write period over which the switch SW4 is open.

Since the gray level to be displayed on the pixel PX in the m+1-th row corresponds to a drive current with a smaller magnitude, the current I(m+1) that the first operation makes flow through the video signal line DL is smaller in magnitude than the current I(m) described with regard to the pixel PX in the m-th row. Thus, the gate potential of the drive control element DR1 just after finishing the first operation differs from that described with regard to the pixel PX in the m-th row. In the example shown in FIG. 2, the gate potential of the drive control element DR1 is set at +5.5 V by passing the current I(m+1).

The gate potential of the drive control element DR2 just after finishing the first operation is set at a value equal to the gate potential of the drive control element DR1, +5.5 V in this example. The change in the gate potential of the drive control element DR2 caused by the second operation is equal to that described with regard to the pixel PX in the m-th row. Therefore, in this example, the gate potential of the drive control element DR2 changes from +5.5 V to −2.5 V by executing the second operation.

Thus, during the effective display period over which a gray level corresponding a drive current with a smaller magnitude is to be displayed on the pixel PX in the m+1-th row, the electrical resistance of the drive control element DR2 is larger than that during the effective display period over which a gray level corresponding a drive current with a larger magnitude is to be displayed on the pixel PX in the m-th row. Therefore, the drive current that flows through the display element OLED has a sufficiently small magnitude. According to the method shown in FIG. 2, a gray level corresponding to a drive current with a smaller magnitude is displayed as described above.

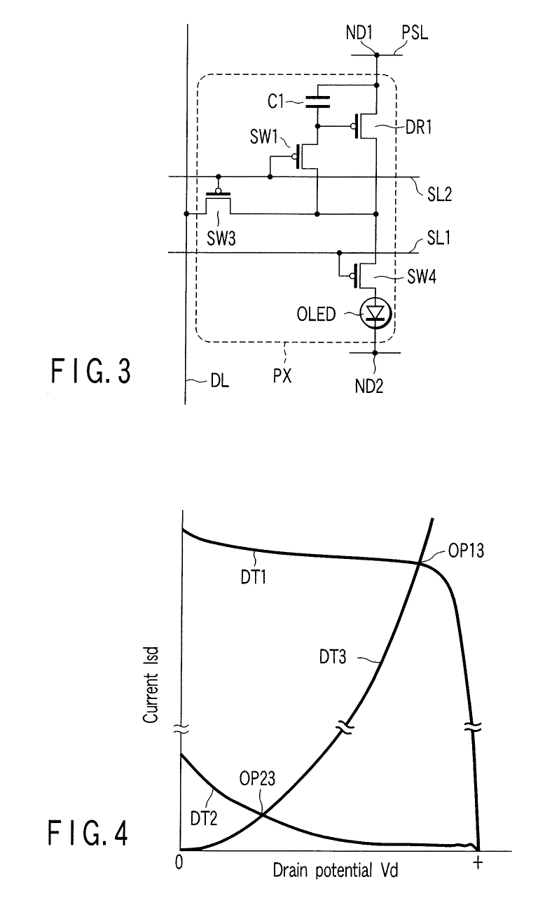

In the case of omitting the drive control element DR2, capacitor C2 and switch SW2 in each pixel PX, it is difficult to set magnitude of the drive current at a sufficiently small value. This is described with reference to FIGS. 3 and 4.

FIG. 3 is an equivalent circuit diagram showing the pixel PX from which the second drive control element DR, the second capacitor C2, and the second switch SW2 are omitted. FIG. 4 is a graph showing an example of volt-ampere characteristics of the drive control element DR1 in the pixel PX shown in FIG. 3.

In FIG. 4, the abscissa denotes a drain potential V_{d} of the drive control element DR1, while the ordinate denotes a current I_{sd} that flows between the source and drain of the drive control element DR1 or a drive current that flows through the display element OLED.

The curves DT1 to DT3 in FIG. 4 show data when the potential of the power supply terminal ND1 is set at +6 V, and the potential of the power supply terminal ND2 is set at −9 V. Specifically, the curve DT1 shows a volt-ampere characteristic of the drive control element DR1 when a video signal corresponding to a drive current with the maximum magnitude is written on the pixel PX by the same method described with reference to FIGS. 1 and 2. The curve DT2 shows a volt-ampere characteristic of the drive control element DR1 when a video signal corresponding to a drive current with the minimum magnitude is written on the pixel PX by the same method described with reference to FIGS. 1 and 2. The curve DT3 shows a volt-ampere characteristic of the display element OLED.

Further, in FIG. 4, the intersection point OP13 of the curves DT1 and DT3 represents the operation point of the drive control element when the drive current with the maximum magnitude is made to flow through the display element OLED. The intersection point 0P23 of the curves DT2 and DT3 represents the operation point of the drive control element when the drive current with the minimum magnitude is made to flow through the display element OLED.

As the curve DT2 in FIG. 4, when the video signal corresponding to the drive current with the minimum magnitude is written on the pixel PX, the lower the drain potential V_{d}, the larger the current I_{sd} becomes, within a range that the drain potential V_{d} of the drive control element DR1 is low. Therefore, the drive current can have a small magnitude by shifting the intersection point OP23 such that the drain potential V_{d} at the operation point becomes higher.

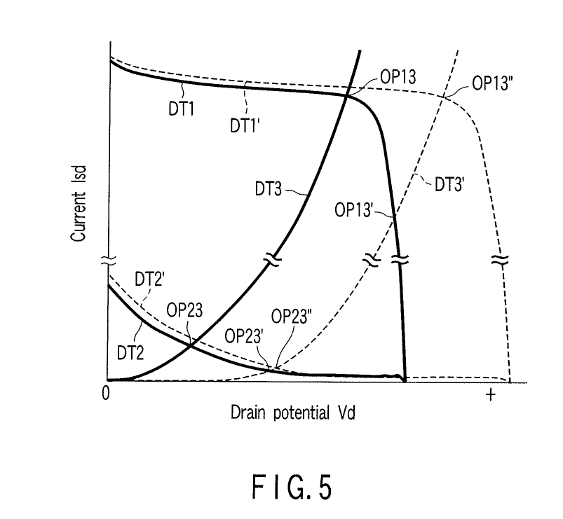

Such a shifting of the intersection point OP23 can be performed by, for example, raising the potential of the scan signal line SL1 during the effective display period to make the electrical resistance of the output control switch SW4 larger. This is described with reference to FIG. 5.

FIG. 5 is a graph showing another example of volt-ampere characteristics of the drive control element DR1 in the pixel PX shown in FIG. 3.

In FIG. 5, the abscissa denotes a drain potential V_{d} of the drive control element DR1, while the ordinate denotes a current I_{sd} that flows between the source and drain of the drive control element DR1 or a drive current that flows through the display element OLED.

The curve DT1′ in FIG. 5 shows a volt-ampere characteristic of the drive control element DR1 when a video signal corresponding to a drive current with the maximum magnitude is written on the pixel PX by the same method described with reference to FIGS. 1 and 2 except that the potential of the power supply terminal ND1 is set at +10 V. The curve DT2′ shows a volt-ampere characteristic of the drive control element DR1 when a video signal corresponding to a drive current with the minimum magnitude is written on the pixel PX by the same method described with reference to FIGS. 1 and 2 except that the potential of the power supply terminal ND1 is set at +10V. The curve DT3′ shows a volt-ampere characteristic of the display element OLED when an electrical resistance of the output control switch SW4 is increased and the increment is assumed to be an electrical resistance of the display element OLED.

As shown in FIG. 5, when the electrical resistance of the output control switch SW4 is increased, the volt-ampere characteristic of the display element OLED changes from the curve DT3 to the curve DT3′. As apparent by comparing the intersection point OP23′ of the curves DT3′ and DT2 with the intersection point OP23, when the electrical resistance of the output control switch SW4 is increased, it is possible to decrease the minimum magnitude of the drive current.

In this case, however, the curve DT3′ intersects the curve DT1 at the intersection point OP13′. That is, the drive control element DR1 cannot be operated in the saturation region in which the magnitude of the current I_{sd} is almost constant. As a result, the drive control element DR1 is operated in the linear region in which the magnitude of the current I_{sd} greatly changes in accordance with the drain potential V_{d}. Further, the maximum magnitude of the drive current becomes smaller.

Raising the potential of the power supply terminal ND1 can prevent this. With this, the curve DT1 can be changed to, for example, the curve DT1′. The intersection point OP13″ of the curves DT1′ and DT3′ is located in the saturation region and gives almost the same drive current magnitude as that at the intersection point OP13 of the curves DT1 and DT3. In addition, since the change from the curve DT2 to the curve DT2′ incident to raising the potential of the power supply terminal ND1 is slight, the magnitude of the drive current at the intersection point OP23″ of the curves DT2′ and DT3′ is almost equal to that at the intersection point OP23′ of the curves DT2 and DT3′. Therefore, if the electrical resistance of the output control switch SW4 is increased and the potential of the power supply terminal ND1 is raised, the drive control element DR1 can be operated in the saturation region when the drive current has the maximum magnitude. In addition, it is possible to decrease the minimum magnitude of the drive current.

However, when the potential of the power supply terminal ND1 is raised, the power consumption becomes larger, and the load on the video signal line driver XDR and the like increase.

If the configuration shown in FIG. 1 is employed in the pixel PX, as described with reference to FIGS. 1 and 2, it is possible to decrease the electrical resistance of the drive control element DR2 when a gray level corresponding to a drive current with a larger magnitude is to be displayed. In addition, it is possible to increase the electrical resistance of the drive control element DR2 when a gray level corresponding to a drive current with a smaller magnitude is to be displayed. That is, the curve DT3 shown in FIG. 4 can be deformed such that it intersects the curve DT2 at a higher drain potential V_{d} without changing the position of the intersection point of the curves DT3 and DT1, for example. As a result, it becomes possible to make the minimum magnitude of the drive current smaller, and operate the drive control element DR1 in the saturation region without raising the potential of the power supply terminal ND1 when the drive current has the maximum magnitude.

The second embodiment of the present invention will be described below.

In the display according to the first embodiment, the operations of the drive control element DR2 and switch SW4 are controlled by the scan signal that the scan signal line driver YDR supplies to them via the scan signal line SL1. Thus, in the display according to the first embodiment, the operations of the drive control element DR2 and output control switch SW4 cannot be controlled independently.

In the display according to the second embodiment, a scan signal line for controlling the operation of the output control switch SW4 is provided separately from the scan signal line SL1 for controlling the operation of the drive control element DR2. This makes it possible independently controlling the operations of the drive control element DR2 and output control switch SW4.

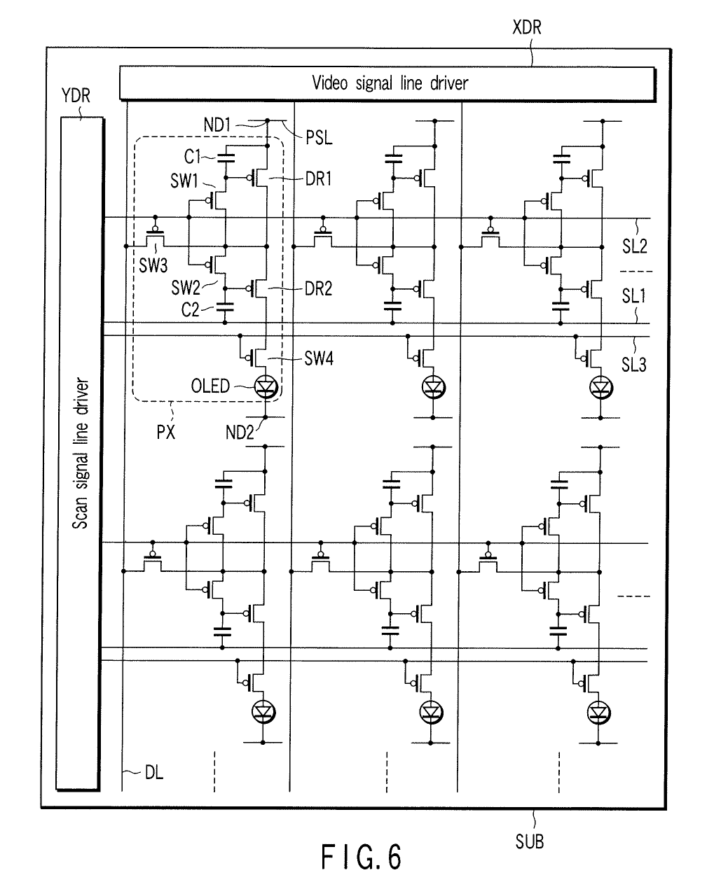

FIG. 6 is a plan view schematically showing a display according to the second embodiment of the present invention. The display is an active matrix display, for example, an active matrix organic EL display. The display shown in FIG. 6 is the same structure as that of the display shown in FIG. 1 except for the following configuration.

The display shown in FIG. 6 includes third scan signal lines SL3 correspondently with the rows of the pixels PX. Each gate of the output control switches SW4 is connected to not the scan signal line SL1 but the scan signal line SL3.

The display can be driven by, for example, the same method described with reference to FIGS. 1 and 2 except that the same scan signal is supplied to the scan signal lines SL1 and SL3. In this case, the same effect that described in the first embodiment can be achieved.

Further, in the display shown in FIG. 6, the magnitude of the scan signal supplied to the scan signal line SL1 can differ from the magnitude of the scan signal supplied to the scan signal line SL3. Therefore, it is possible to set the magnitude of the scan signal to be supplied to the scan signal line SL3 at a value most suitable for controlling the switching operation of the output control switch SW4, while supplying a scan signal with any given magnitude to the scan signal line SL1. Thus, by executing the second operation, the gate potential of the drive control element DR2 can be changed by a desired displacement independently with the switching operation of the output control switch SW4.

The displays according to the first and second embodiments can be modified variously.

For example, although the switch SW1 is connected between the gate and drain of the drive control element DR1 in each display shown in FIGS. 1 and 6, the switch SW1 may be connected between the gate of the drive control element DR1 and the video signal line DL. In this case, the switch SW2 may be connected between the gate of the drive control element DR2 and the drain of the drive control element DR1, or between the gate of the drive control element DR2 and the video signal line DL, or between the gate of the drive control element DR2 and the gate of the drive control element DR1.

When the switch SW1 is connected between the gate of the drive control element DR1 and the video signal line DL, while the switch SW2 is connected between the gate of the drive control element DR2 and the drain of the drive control element DR1, the switch SW3 may be connected between the drain of the drive control element DR1 and the video signal line DL. Alternatively, the switch SW3 may be connected between the drain of the drive control element DR1 and the gate of the drive control element DR1.

When the switch SW1 is connected between the gate of the drive control element DR1 and the video signal line DL, while the switch SW2 is connected between gate of the drive control element DR2 and the video signal line DL, the switch SW3 may be connected between the drain of the drive control element DR1 and the video signal line DL. Alternatively, the switch SW3 may be connected between the drain and gate of the drive control element DR1, or between the drain of the drive control element DR1 and the gate of the drive control element DR2.

The switch SW1 may be connected between the gate of the drive control element DR1 and the gate of the drive control element DR2. In this case, the switch SW2 may be connected between the gate of the drive control element DR2 and the drain of the drive control element DR1, or between the gate of the drive control element DR2 and the video signal line DL.

When the switch SW1 is connected between the gate of the drive control element DR1 and the gate of the drive control element DR2, while the switch SW2 is connected between the gate of the drive control element DR2 and the drain of the drive control element DR1, the switch SW3 may be connected between the drain of the drive control element DR1 and the video signal line DL. Alternatively, the switch SW3 may be connected between the gate of the drive control element DR1 and the video signal line DL, or between the gate of the drive control element DR2 and the video signal line DL.

When the switch SW1 is connected between the gate and drain of the drive control element DR1 as shown in FIGS. 1 and 6, the switch SW2 may be connected between the gate of the drive control element DR2 and the drain of the drive control element DL1, or between the gate of the drive control element DR2 and the video signal line DL, or between the gate of the drive control element DR2 and the gate of the drive control element DR1.

When the switch SW1 is connected between the gate and drain of the drive control element DR1, while the switch SW2 is connected between the gate of the drive control element DR2 and the drain of the drive control element DR1, the switch SW3 may be connected between the drain of the drive control element DR1 and the video signal line DL as shown in FIGS. 1 and 6. Alternatively, the switch SW3 may be connected between the gate of the drive control element DR1 and the video signal line DL, or between the gate of the drive control element DR2 and the video signal line DL.

The switches SW1 and SW3 may be connected in series between the gate of the drive control element DR1 and the video signal line DL in this order. In this case, the terminal of the switch SW1 that is connected to the switch SW3 is connected to the drain of the drive control element DR1. Also in this case, the switch may be connected between the gate of the drive control element DR2 and the drain of the drive control element DR1, or between the gate of the drive control element DR2 and the video signal line DL, or between the gate of the drive control element DR2 and the gate of the drive control element DR1, or between the gate of the drive control element DR2 and the terminal of the switch SW1 that is connected to the switch SW3.

The switches SW2 and SW3 may be connected in series between the gate of the drive control element DR2 and the video signal line DL in this order. In this case, the terminal of the switch SW2 that is connected to the switch SW3 is connected to the drain of the drive control element DR1. Also in this case, the switch SW1 may be connected between the gate of the drive control element DR1 and the drain of the drive control element DR1, or between the gate of the drive control element DR1 and the video signal line DL, or between the gate of the drive control element DR1 and the gate of the drive control element DR2, or between the gate of the drive control element DR1 and the terminal of the switch SW2 that is connected to the switch SW3.

Although p-channel TFTs are used as the drive control elements DR1 and DR2 in the displays shown in FIGS. 1 and 6, n-channel TFTs may be used as them. In this case, the potential of the power supply terminal ND1 is set lower than that of the power supply terminal ND2, and the anode and cathode of the display element OLED are connected to the power supply terminal ND2 and output control switch SW4, respectively. Also in this case, an n-channel TFT is used as the TFT of the output control switch SW4.

Although p-channel TFTs are used as the switch SW1 to SW3 in the displays shown in FIGS. 1 and 6, n-channel TFTs may be used as them.

Although each row of the pixels PX is provided with only one scan signal line in order to control the switching operations of the switches SW1 to SW3 in the displays shown in FIGS. 1 and 6, each row may be provide with two or three scan signal lines. That is, the structure by which the switching operations of the switches SW1 to SW3 included in each pixel PX can be controlled independently may be employed.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A display comprising pixels arranged in a matrix, first scan signal lines arranged correspondently with rows which the pixels form, and video signal lines arranged correspondently with columns which the pixels form,
wherein each of the pixels comprises:
a first drive control element including a first control terminal, a first input terminal connected to a first power supply terminal, and a first output terminal outputting a current whose magnitude corresponds to a voltage between the first control terminal and the first input terminal;
a second drive control element including a second control terminal, a second input terminal connected to the first output terminal, and a second output terminal outputting a current whose magnitude corresponds to a voltage between the second control terminal and the second input terminal;
a first capacitor connected between a constant potential terminal and the first control terminal;
a second capacitor connected between the first scan signal line and the second control terminal;
a display element whose optical characteristic changes in accordance with a magnitude of current flowing therethrough;
an output control switch connected in series with the display element between the second output switch and a second power supply terminal; and
a switch group switching a connection state of the first and second control terminals, the first output terminal, and the video signal line between first and second states, the first state being a state where the first and second control terminals, the first output terminal, and the video signal line are connected to one another, and the second state being a state where the first and second control terminals, the first output terminal, and the video signal line are disconnected from one another.

2. The display according to claim 1, wherein the display is configured to sequentially execute first and second operations in a write period during which the output control switch is opened, the first operation including causing a write current to flow through the video signal line while the connection state is set to the first state and a potential of the first scan signal line is set at a first potential, and the second operation including shifting the potential of the first scan signal line from the first potential to a second potential while the connection state is set to the second state, and
wherein the display is configured to cause a drive current corresponding to the write current to flow through the display element while keeping the connection state to the second state and the potential of the first scan signal line at the second potential in an effective display period during which the output switch is closed.

3. The display according to claim 2, wherein the display is configured to decrease an electrical resistance between the second input terminal and the second output terminal by the second operation.

4. The display according to claim 1, further comprising second scan signal lines arranged correspondently with the rows which the pixels form,
wherein the switch group includes a first switch with a terminal connected to the first control terminal, a second switch with a terminal connected to the second control terminal, and a third switch with a terminal connected to the first output terminal or the video signal line, and
wherein, in each of the pixels, control terminals of the first to third switches are connected to the second scan signal line.

5. The display according to claim 1, wherein, in each of the pixels, a control terminal of the output control switch is connected to the first scan signal line.

6. The display according to claim 1, further comprising third scan signal lines arranged correspondently with the rows which the pixels form,
wherein, in each of the pixels, a control terminal of the output control switch is connected to the third scan signal line.

7. The display according to claim 1, wherein the display element is an organic EL element.

8. A method of driving the display according to claim 1, comprising:
sequentially executing first and second operations in a write period during which the output control switch is opened, the first operation including causing a write current to flow through the video signal line while the connection state is set to the first state and a potential of the first scan signal line is set at a first potential, and the second operation including shifting the potential of the first scan signal line from the first potential to a second potential while the connection state is set to the second state; and
causing a drive current corresponding to the write current to flow through the display element while keeping the connection state to the second state and the potential of the first scan signal line at the second potential in an effective display period during which the output switch is closed.

9. The method according to claim 8, wherein an electrical resistance between the second input terminal and the second output terminal is decreased by the second operation.
